(19) United States
(12) Patent Application Publication
(10) Pub. No.: US 2008/0008339 A1
(43) Pub. Date: Jan. 10, 2008

(54) Audio processing system and method

(76) Inventors: James G. Ryan, Ottawa (CA); Stephen W. Armstrong, Burlington (CA)

Correspondence Address: Joseph M. Sauer, Esq.;JONES DAY, North Point, 901 Lakeside Avenue, Cleveland, OH, 44114, US

(21) Appl. No.: 11/481,171

(22) Filed: Jul. 5, 2006

(51) Int. Cl. H04R 25/00

(52) U.S. Cl. 381/313

(57) ABSTRACT

A system for receiving and processing audio signals includes a handheld audio processing device and an audio receiver unit. The handheld audio processing device has a plurality of microphones located on the handheld audio processing device that define a surface and at least a pair of intersecting axes on the surface where each of the axes is defined by at least two microphones. The handheld audio processing device also has a processing subsystem configured to receive audio signals generated by the plurality of microphones and to spatially filter the audio signals and a transmitter configured to transmit the spatially filtered audio signals. The audio receiver unit is located remote from the handheld audio processing device and configured to receive the spatially filtered audio signals transmitted by the handheld audio transmitter.

### BACKGROUND

People with hearing impairments often wear hearing aids to better hear the voices and sounds around them. Some hearing aid systems include a handheld wireless transmitter that processes audio signals received from the surrounding environment and transmits the processed audio signals to the hearing aids worn by a user. These handheld devices typically include several microphones arranged in a line array for directional sound pickup. The handheld devices are typically capable of only monophonic sound pickup and the main sound pickup direction cannot be changed without physically moving the device.

### SUMMARY

In one embodiment, a novel system for receiving and processing audio signals comprises a handheld audio processing device and an audio receiver unit. The handheld audio processing device includes several microphones that define a surface and at least a pair of intersecting axes on the surface. Each of the axes is defined by at least two microphones. The handheld audio processing unit also includes a processing subsystem and a transmitter. The processing subsystem is configured to receive audio signals that are generated by the microphones, and to spatially filter the audio signals. The transmitter is configured to transmit the spatially filtered audio signals. The audio receiver unit is located remote from the handheld audio processing device. The audio receiver unit is configured to receive the spatially filtered audio signals transmitted by the handheld audio transmitter.

In another embodiment, a novel system for receiving and processing audio signals comprises a handheld audio processing device and a pair of hearing instruments. The handheld audio processing device includes microphones, a processing subsystem and a transmitter. The microphones are located on the handheld audio processing device and define coincident pairs of microphones. The processing subsystem is configured to receive audio signals from the microphones and to generate stereophonic audio signals from the audio signals. The transmitter is configured to transmit the stereophonic audio signals. The pair of hearing instruments is located remote from the handheld audio processing device and is configured to receive the stereophonic audio signals transmitted from the handheld audio processing device.

### BRIEF DESCRIPTION OF THE DRAWINGS

FIG. 1 is a block diagram of a handheld audio processing device.

FIG. 2 is a block diagram of an audio receiver unit.

FIGS. 3-6 are illustrations of microphone selections to facilitate sound pickup strategies for spatially filtering audio signals.

FIG. 7 is a block diagram of a microphone-signal averaging circuit.

FIG. 8 is a block diagram of a sound pickup strategy that can be implemented using the microphone arrangement.

FIG. 9 is a flowchart of an example method for receiving and processing audio signals.

FIG. 10 is a flowchart of an example method for receiving and processing audio signals.

### DETAILED DESCRIPTION

The parts shown in the drawings include examples of the structural elements recited in the claims. The illustrated parts thus include examples of how a person of ordinary skill in the art can make and use the claimed invention. They are described here to provide enablement and best mode without imposing limitations that are not recited in the claims.

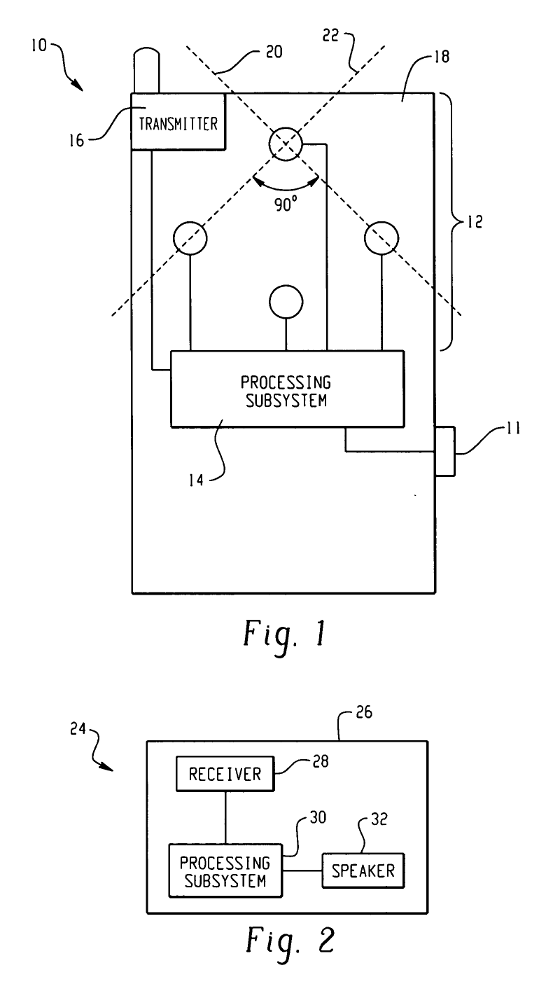

FIG. 1 is a block diagram of a handheld audio processing device 10. The handheld audio processing device 10 comprises a plurality of microphones 12, a processing subsystem 14, and a transmitter 16. The handheld audio processing device 10 is designed to be held by a person in the vicinity of sounds that are to be received by the microphones 12 and processed.

The plurality of microphones 12 are arranged on a surface 18 so that at least two pairs of the microphones 12 define intersecting axes 20 and 22 on the surface 18 of the handheld audio processing device 10. The intersecting axes 20 and 22 may intersect at an angle of 90 degrees as shown in FIG. 1. The plurality of microphones 12 may be omni directional microphones, but unidirectional microphones may also be used.

The handheld audio processing device 10 includes a processing subsystem 14. The processing subsystem 14 is configured to receive audio signals that are generated from the plurality of microphones 12 and to spatially filter the audio signals. The processing subsystem 14 may be configured to spatially filter audio signals from a subset of the plurality of microphones 12 based either on a processing configuration in the processing subsystem 14 or on a user selection received via a user input 11.

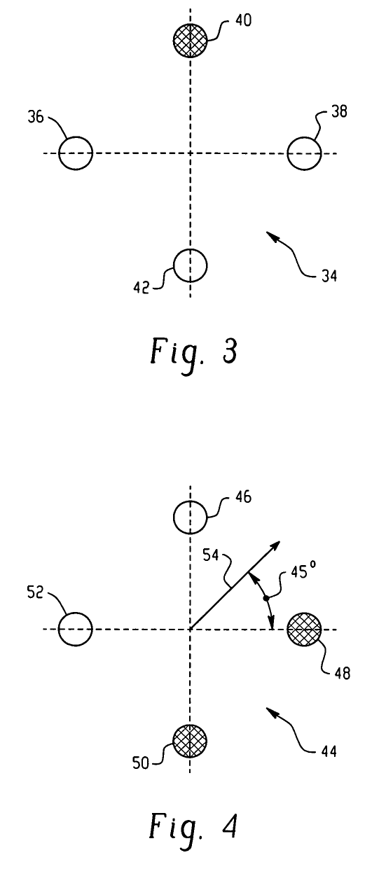

The transmitter 16 is configured to transmit the audio signals that are spatially filtered by the processing subsystem 14. The transmitter 16 may transmit the signals to an audio receiver unit 24, which is discussed in FIG. 2.

FIG. 2 is a block diagram of an audio receiver unit 24. The audio receiver unit 24 may be a hearing aid. The audio receiver unit comprises an earpiece 26, a receiver 28, a processing subsystem 30, and a speaker 32. The earpiece 26 may be designed to fit within the ear, or alternatively, rest on the ear. In one embodiment, the system may include two audio receiver units 24, each worn on a different ear.

The receiver 28 and the processing subsystem 30 are designed to receive and process the spatially filtered audio signals transmitted by the handheld audio transmitter 26. The spatially filtered audio signals are received by the receiver 28 and are subsequently processed by the processing subsystem 30 to generate electrical signals to drive the speaker 32. The speaker 32, in turn, generates an acoustic signal heard by the user wearing the audio receiver unit 24.

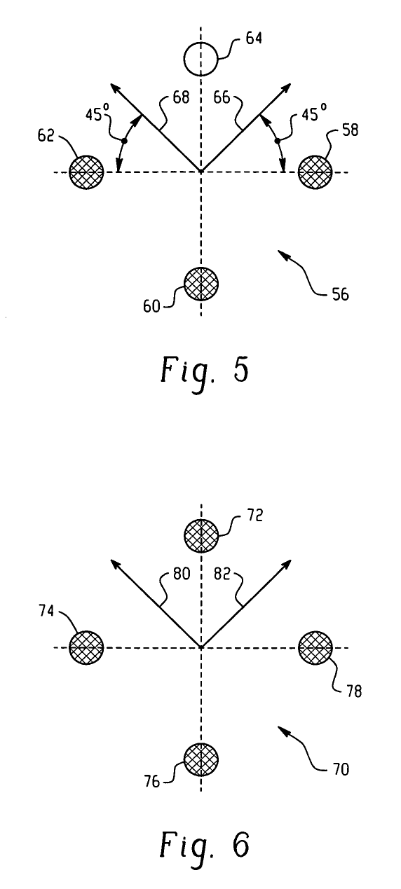

FIG. 3 is an illustration of a microphone selection 34 to facilitate one sound pick-up strategy for spatially filtering audio signals. In this embodiment, one microphone 40 is configured to be activated, and the other three microphones 36, 38 and 42 are not activated. The activated microphone 40 picks up omni directional sound in one direction, and the processing subsystem produces a monophonic audio signal which is transmitted to the audio receiver unit. Alternatively, an omni directional sound pick-up strategy can be implemented by activating more than one microphone, and summing the signals from the activated microphones.

FIG. 4 is another illustration of a microphone selection 44 to facilitate another sound pick-up strategy for spatially filtering audio signals. This selection 44 can be used to produce a monophonic, first-order directional sound pickup pattern (beam). In this example, microphones 48 and 50 are configured to be activated, and microphones 46 and 52 are not activated. This first order sound pickup pattern is implemented by configuring microphone 48 as the front microphone and microphone 50 as the rear microphone. The optionally delayed signal from rear microphone 50 is subtracted from the signal from front microphone 48 to generate an audio signal with its main beam directed along line 54. It should be understood that various coincident pairs of microphones in the arrangement can be used to produce signals in directions other than direction 54.

FIG. 5 is an illustration of a sound pick-up strategy 56 utilizing three of the four microphones in the arrangement. Microphones 58, 60 and 62 are activated, and microphone 64 is not activated. The microphones in this scenario can be used to generate two monophonic sound pick-up directions 66 and 68. Sounds picked-up along directions 66 and 68 can be transmitted to audio receiver units worn on alternate ears, creating stereophonic playback. To generate sound pickup in direction 66, microphone 58 is the front microphone and microphone 60 is the rear microphone. Subtracting rear microphone 60 from front microphone 58 generates the pickup beam 66 oriented 45 degrees to the right of the y-axis. This audio signal can be transmitted to the audio receiver unit located on the right ear of the listener.

The left-ear sound signal in direction 68 is similarly generated. To generate the left signal oriented along direction 68, microphone 62 is the front microphone and microphone 60 is the rear microphone. The signal from rear microphone 60 is subtracted from the signal from the front microphone 62. The result is a pickup beam directed 45 degrees to the left of the y-axis 68, which can be transmitted to the audio receiver unit located on the left ear of the listener. Transmitting these signals to the left and right audio receiver units results in stereophonic sound for the listener. Signals in directions other than direction 68 and 66 can be similarly generated using different combinations of activated microphones 58, 60, 62 and 64.

FIG. 6 is an illustration of a sound pick-up strategy 70 wherein all four microphones 72, 74, 76 and 78 in the arrangement are used to create stereophonic sound signals along directions 80 and 82. The audio signal along direction 82 can be generated by using microphone coincident pair 78 and 76, or by using microphone coincident pair 72 and 74. Activating all four microphones can generate two independent directional signals in the direction 82. Averaging these two independent directional signals can reduce the overall noise present in the microphone system. In one embodiment, the averaging of the signals is performed prior to the time delay and subtraction necessary to implement the directional pickup pattern. Similar processing can be performed to generate the audio signal in direction 80. The signal in direction 80 can be implemented by using either microphone coincident pair 72 and 78 or microphone coincident pair 74 and 76. It should be noted that signals can be generated in directions other than directions 80 and 82 by variations in the processing of the individual microphone signals.

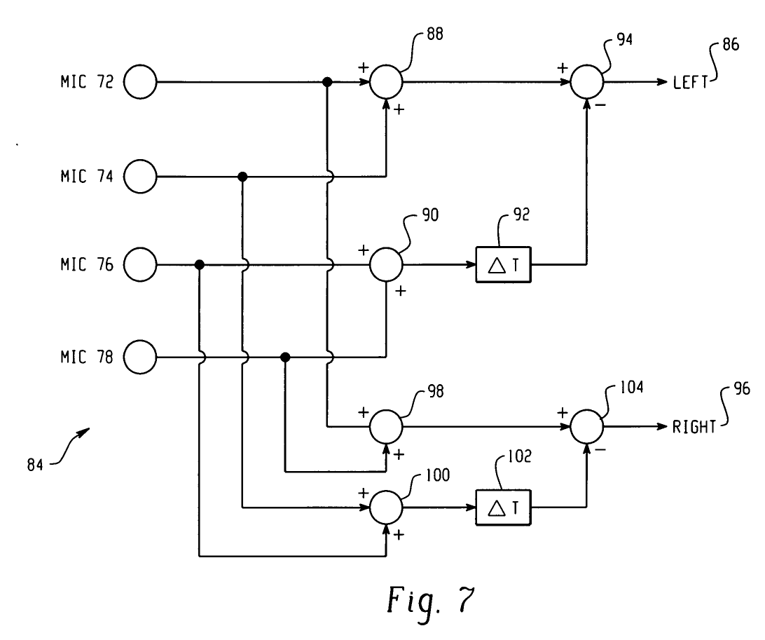

FIG. 7 is a block diagram of an example microphone-signal averaging circuit 84 that can be used to implement the sound pickup strategy of FIG. 6. The term “element” used herein may refer to software, hardware, or a combination of software and hardware. To generate the left stereophonic signal 86, the signals generated from microphone 72 are added to the signal from microphone 74 at summation element 88. The signals from microphone 76 and microphone 78 are added at summation element 90. The signal from summation element 90 is passed through a time delay element 92, and is subtracted from the signal from summation element 88 at difference element 94.

The right stereophonic signal 96 is similarly generated. The signal from microphone 72 and the signal from microphone 78 are added at summation element 98. The signal from microphone 74 and the signal from microphone 76 are added at summation element 100. The signal from summation element 100 is then delayed at time delay element 102. The signal from time delay element 102 is subtracted from the signal from summation element 98 at difference element 104 to generate the right stereophonic signal 96.

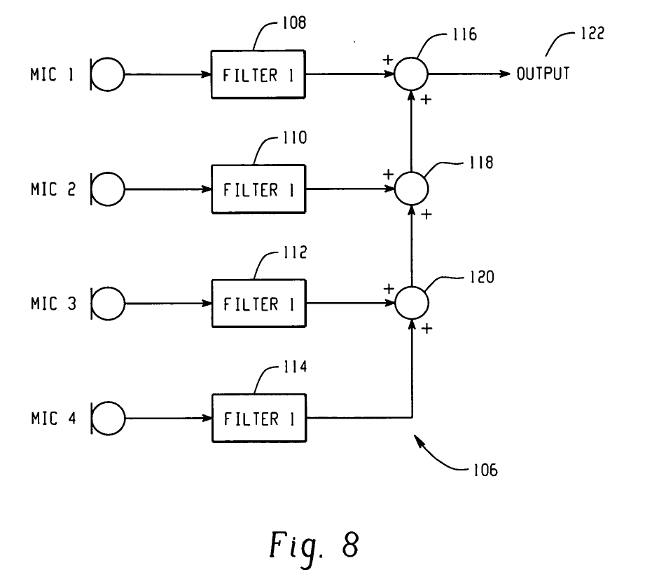

FIG. 8 is a block diagram of another sound pickup strategy that can be implemented using the microphone arrangement. The block diagram 106 depicts the four microphones in the arrangement in a gain optimized multiple microphone array for beam steering. A gain-optimized array can be implemented using any combination of two or more microphones. Filter elements 108, 110, 112 and 114 are configured to filter the signal generated by each of the four microphones. Each of the signals from the filters 108, 110, 112 and 114 are then added at summation elements 116, 118 and 120. The output of summation element 116 is the beam steered audio signal 122.

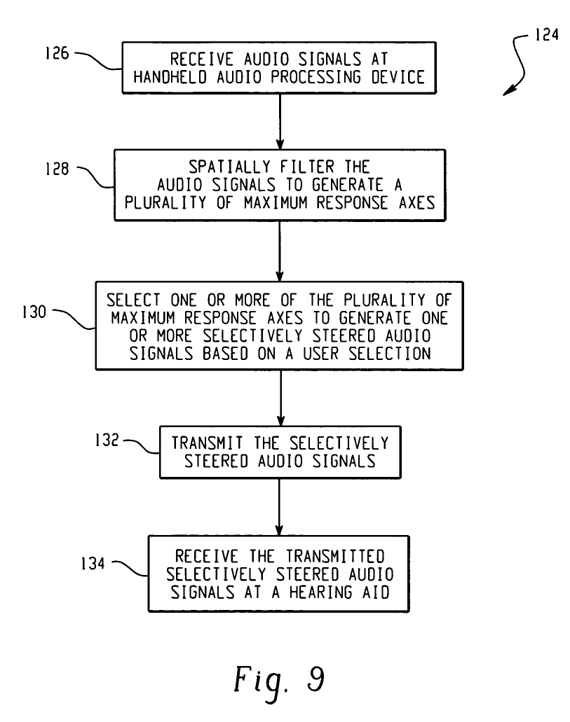

FIG. 9 is a flowchart of an example method for receiving and processing audio signals 124. The process begins at step 126, where audio signals are received by the handheld audio processing device through the plurality of microphones on the surface of the handheld audio processing device. In step 128, the audio signals are spatially filtered to generate a plurality of maximum response axes. The maximum response axes are generated by spatially filtering the signals from the plurality of microphones that are present in the microphone arrangement on the handheld audio processing device.

In step 130, one or more of the plurality of maximum response axes that were generated in step 84 are selected. From the maximum response axes that are selected, one or more selectively steered audio signals is generated. The selection may be based on a default selection and position of the microphones if no user selection is made. Alternatively, the selection may be made by a user. In step 132, the audio signals are transmitted.

Finally, in step 134, an audio receiver unit receives the selectively steered audio signals transmitted by the handheld audio processing device. The audio receiver unit may be a hearing aid embedded in the ear of a listener.

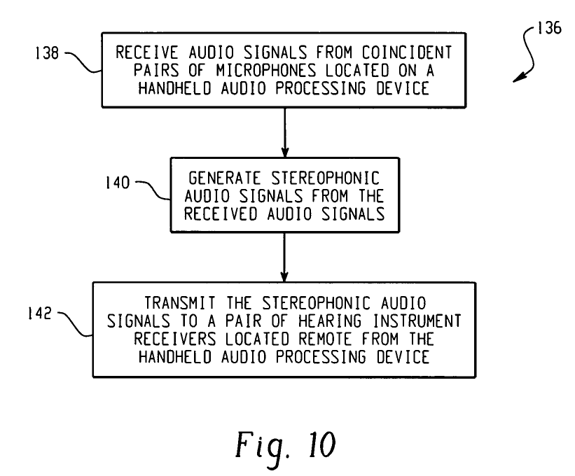

FIG. 10 is a flowchart illustrating an example of a method for receiving and processing audio signals 136. In step 138, audio signals are received from the coincident pairs of microphones located on the handheld audio processing device. In step 140, the handheld audio processing device generates stereophonic audio signals from the audio signals received from the coincident pairs of microphones in step 138. In step 142, the stereophonic audio signals generated in step 140 are transmitted to a pair of hearing instruments located remote from the handheld audio processing unit.

This written description sets forth the best mode of carrying out the invention, and describes the invention to enable a person of ordinary skill in the art to make and use the invention, by presenting examples of the structural elements recited in the claims. The patentable scope of the invention is defined by the claims and may include other examples that occur to those skilled in the art. Such other examples, which may be available either before or after the application filing date, are intended to be within the scope of the claims if they have structural elements that do not differ from the literal language of the claims, or if they have equivalent structural elements with insubstantial differences from the literal language of the claims.

What is claimed is:

1. A system for receiving and processing audio signals, comprising:
a handheld audio processing device, comprising:
a plurality of microphones located on the handheld audio processing device, the plurality of microphones defining a surface and at least a pair of intersecting axes on the surface, each of the axes defined by at least two microphones;
a processing subsystem configured to receive audio signals generated by the plurality of microphones and spatially filter the audio signals; and
a transmitter configured to transmit the spatially filtered audio signals; and
an audio receiver unit located remote from the handheld audio processing device and configured to receive the spatially filtered audio signals transmitted by the handheld audio transmitter.

2. The system of claim 1 wherein the microphones are omni directional microphones.

3. The system of claim 1 wherein the audio receiver unit is a hearing aid.

4. The system of claim 3 wherein the transmitter is a wireless transmitter and the audio receiver unit is a wireless receiver.

5. The system of claim 1 wherein the processing subsystem is further configured to selectively process a subset of the plurality of microphones based on a user selection.

6. The system of claim 1 wherein the processing subsystem is further configured to select one of a plurality of maximum response axes for spatially filtering the audio signals based on a user selection.

7. The system of claim 1 wherein each pair of intersecting axes intersects at an angle of 90 degrees.

8. A method for receiving and processing audio signals, comprising:
receiving audio signals at a handheld audio processing device;
spatially filtering the audio signals to generate a plurality of maximum response axes;
selecting one or more of the plurality of maximum response axes to generate one or more selectively steered audio signals based on a user selection;
transmitting the selectively steered audio signals; and
receiving the transmitted selectively steered audio signals at a hearing aid.

9. The method of claim 8 wherein the plurality of microphones are omni directional microphones.

10. The method of claim 8 wherein the plurality of microphones is arranged on the handheld audio processing device to define a surface and at least a pair of intersecting axes on the surface, each of the axes defined by at least two microphones.

11. The method of claim 8 wherein each pair of intersecting axes intersects at an angle of 90 degrees.

12. A system for receiving and processing audio signals, comprising:
a handheld audio processing device, comprising:
a plurality of microphones located on the handheld audio processing device, the plurality of microphones defining coincident pairs of microphones;
a processing subsystem in the handheld audio processing device configured to receive audio signals from the coincident pairs of microphones and to generate stereophonic audio signals from the audio signals;
a transmitter configured to transmit the stereophonic audio signals; and
a pair of hearing instruments located remote from the handheld audio processing device and configured to receive the stereophonic audio signals transmitted from the handheld audio processing device.

13. The system of claim 12 wherein the pair of hearing instruments comprise a pair of hearing aids.

14. The system of claim 12 wherein the plurality of microphones are unidirectional microphones.

15. The system of claim 13 wherein the pair of hearing instruments are configured to each receive one channel of the stereophonic audio signal transmitted from the handheld audio processing device.

16. The system of claim 15 wherein the handheld audio processing device is further configured to switch channels in the transmitted stereophonic audio signals based on a user input.

17. A method for receiving and processing audio signals, comprising:
receiving audio signals from coincident pairs of microphones located on a handheld audio processing device;
generating stereophonic audio signals from the received audio signals; and
transmitting the stereophonic audio signals to a pair of hearing instrument receivers located remote from the handheld audio processing device.

18. The method claim 17 wherein the microphones are unidirectional microphones.

19. The method claim 17 wherein the audio receiver units comprise a pair of hearing aids.

20. The method of claim 19 wherein the pair of hearing aids are configured to each receive one channel of the stereophonic audio signal transmitted from the handheld audio processing device.

21. A system for receiving and processing audio signals, comprising:
means for receiving audio signals from coincident pairs of microphones located on a handheld audio processing device;
means for generating stereophonic audio signals from the received audio signals; and
means for transmitting the stereophonic audio signals to a pair of hearing instrument receivers located remote from the handheld audio processing device.

22. A system for receiving and processing audio signals, comprising:
means for receiving audio signals at a handheld audio processing device;
means for spatially filtering the audio signals to generate a plurality of maximum response axes;
means for selecting one or more of the plurality of maximum response axes to generate one or more selectively steered audio signals;
means for transmitting the selectively steered audio signals; and
means for receiving the transmitted selectively steered audio signals.
